(19) United States
(12) Patent Application Publication
(10) Pub. No.: US 2008/0294769 A1
(43) Pub. Date: Nov. 27, 2008

(54) Efficient synchronization of agents starting a task where the agents poll a server to learn the task start time

(76) Inventors: Kenshi Doi, Kanagawa-ken (JP); Masahiko Kosuda, Tokyo (JP)

Correspondence Address: LAW OFFICES OF MICHAEL DRYJA, 1474 N COOPER RD #105-248, GILBERT, AZ, 85233, US

(21) Appl. No.: 11/754,179

(22) Filed: May 25, 2007

(51) Int. Cl. G06F 15/173

(52) U.S. Cl. 709/224

(57) ABSTRACT

A server sets a task start time equal to a next polling time by a last agent that has most recently polled the server. In response to each of a number of agents, including the last agent, polling the server, the server provides the task start time. At each agent, a task is started at the task start time, such that all the agents start the task at a same time. As such, all the agents except for the last agent have to wait for the task start time to start the task after polling the server, whereas the last agent starts the task immediately after polling the server. The server may also determine a polling interval time based on a number of the agents that have polled the server, where the polling interval time indicates how long each agent waits between successive pollings of the servers.

### FIELD OF THE INVENTION

The present invention relates to a number of agents having to start a task in synchronization with one another, and more particularly to where the agents poll a server to learn the task start time in question.

### BACKGROUND OF THE INVENTION

In many types of situations, a number of agents have to start a task at the same time, such that it is said that the agents synchronously start the task. A task is defined non-restrictively and generally herein as performing one or more computing instructions to achieve a desired operation. An agent is defined non-restrictively and generally herein as a computer program that runs on a computing device, where the agents may run on the same or different computing devices. For example, an agent may be a software routine that waits in the background and performs an action (i.e., a task) when a specified event occurs.

In certain situations, agents periodically poll a server to determine the time at which they should start the task in question. This approach, however, can lead to inefficiencies in synchronizing the agents so that they each start the task at the same time. FIG. 1 shows a timing diagram 100 in accordance with the prior art and that depicts one problem with this approach. The server determines that the task should be started at time 102. However, a first agent may not poll the server until time 104, and thus may not learn of the task start time until the time 104. As such, the first agent delays starting the task until the time 104. Likewise, a second agent may not poll the server until time 106, and thus may not learn of the task start time until the time 106 and does not start the task until the time 106. Furthermore, because the first agent starts the task at the time 104 and the second agent starts the task at the time 106, the task is not started at the first and the second agents at the same time.

To solve the lack of synchronization between the two agents in the situation of FIG. 1, the server may specify that the task start time at some point in the future, so that it is guaranteed that the agents poll the server before the task start time begins. In this way, the agents synchronize the starting of the task. However, such an improved approach is also problematic, as is depicted in FIG. 2, which shows a timing diagram 200 in accordance with the prior art. The server determines at time 202 that the task should be started at time 203. A first agent polls the server at time 204, and thus has to wait from that time until the time 203 to start the task. A second agent polls the server at time 206, and thus also has to wait until the time 203 to start the task. Such waiting by all of the agents (i.e., by both the first agent and the second agent) is inefficient. Because of these and other problems, therefore, there is a need for the present invention.

### SUMMARY OF THE INVENTION

The present invention relates to the efficient synchronization of agents starting a task, where the agents poll a server to learn the task start time. A computerized method of one embodiment of the invention includes a server setting a task start time equal to the next polling time by the last agent that has most recently polled the server. The next polling time is the time at which the last agent is expected to again poll the server. In response to each of a number of agents, including the last agent, polling the server, the server responds with the task start time. Each agent then starts the task at the task start time, such that all of the agents start the task at the same time. As such, the last agent starts the task immediately after polling the server, such that the most efficient synchronization of the agents starting the task is achieved, where all of the agents except the last agent have to wait for the minimum amount of time for the task start time at which they start the task after polling the server.

In one embodiment, the method includes each agent providing an identifier that uniquely identifies the agent (compared to other agents) when polling the server. The server records the identifier of each agent so that the server is able to determine the total number of agents that have polled (and are polling or will poll) the server. The server determines a polling interval time based on the number of the agents that have polled the server. The polling interval time indicates how long each agent waits between successive pollings of the server. Thus, prior to receiving the task start time, each agent in response to polling the server is provided by the server with the polling interval time. As such, each agent waits to again poll the server until the polling interval time has elapsed. In this way, the server is not inundated with pollings by the agents, since the server is able to space out pollings based on the number of agents that are polling the server. That is, the server controls the polling interval time based on the number of agents in question.

A computerized system of an embodiment of the invention includes one or more computing devices and a server that are communicatively connected with one another, such as via a network. Agents run on the computing devices. The server sets a task start time equal to a next polling time by a last agent that has most recently polled the server. In response to each agent polling the server, the server responds with the task start time, and in response each agent starts the task at the task start time. As such, all the agents start the task at the same time. All the agents except for the last agent have to wait for the task start time to start the task after polling the server, but the last agent starts the task immediately after polling the server, such that the most efficient synchronization of the agents in starting the task is achieved.

It is noted that the methods of embodiments of the invention can be implemented by one or more computer programs stored on a computer-readable medium and executed by computing devices, such as the server and the computing devices on which the tasks are running. The computer-readable medium may in one embodiment be a tangible computer-readable medium, such as a recordable data storage medium. Still other aspects, embodiments, and advantages of the present invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a timing diagram depicting attempted synchronization among a number of agents in starting a task, according to the prior art.

FIG. 2 is a timing diagram depicting synchronization among a number of agents in starting a task, also according to the prior art.

FIG. 3 is a diagram of a computerized system, according to an embodiment of the invention.

FIG. 4 is a flowchart of a method for efficiently synchronizing the task start time of a task to be performed by a number of agents that poll a server, according to an embodiment of the invention.

FIG. 5 is a timing diagram depicting efficient synchronization among a number of agents in starting a task, according to an embodiment of the invention.

FIG. 6 is a flowchart of a method for determining a polling interval time that an agent waits before again polling a server, so that the server does not become overloaded with polling requests, according to an embodiment of the invention.

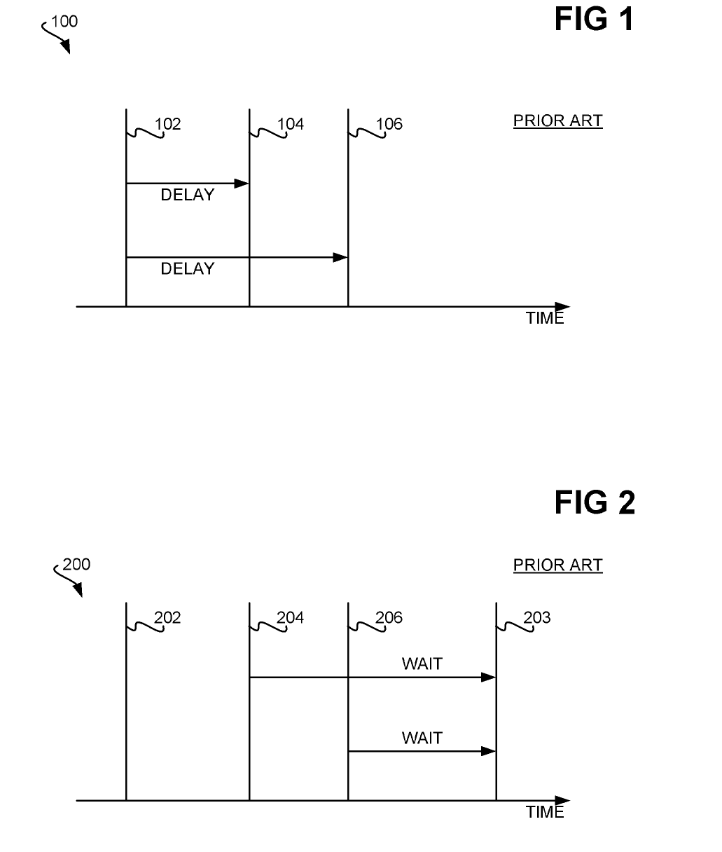

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

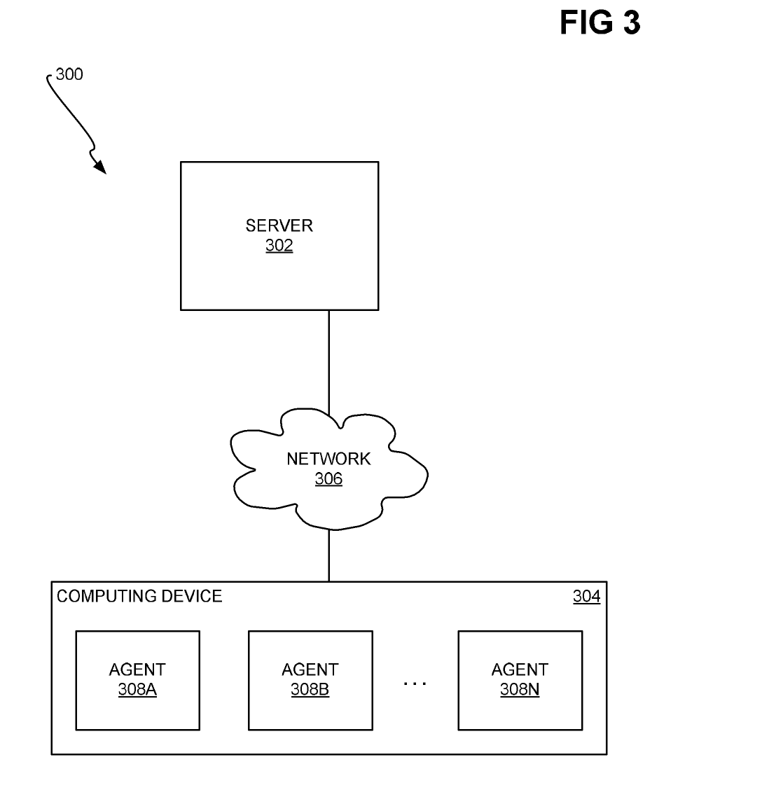

FIG. 3 shows a computerized system 300, according to an embodiment of the invention. In the embodiment of FIG. 3, the system 300 includes a server 302 and a computing device 304 that are communicatively connected with one another over a network 306. Those of ordinary skill within the art can appreciate that variations to the topology depicted in FIG. 3 can be made. The network 306, in embodiments where it is present, can be or include intranets, extranets, local-area networks (LAN's), wide-area networks (WAN's), the Internet, and so on.

The computing device 304 has a number of agents 308A, 308B, . . . , 308N, collectively referred to as the agents 308, running thereon. While just one computing device 304 is depicted in FIG. 3, in another embodiment there may be more than one computing device 304 on which the agents 308 are running. For example, each agent may run on a different computing device, or some agents may run on one computing device and other agents may run on another computing device. The computing device 304 may be a desktop or laptop computing device, including hardware such as one or more processors, memory, storage devices like hard disk drives, and so on.

The server 302 in one embodiment is also a computing device that includes hardware, such as one or more processors, memory, storage devices like hard disk drives, and so on. In one embodiment, however, the server 302 may be considered a controller, which may be implemented in the same computing device as the agents 308. As such, the term server is used generally and non-restrictively herein, and is defined by the functionality it performs as compared to any structural aspects thereof. The server 302, however, in one embodiment may be a hypertext transport protocol (HTTP) server, such as a web server, as can be appreciated by those of ordinary skill within the art.

In such an embodiment, the agents 308 may be web browsing programs that run on the hardware of the computing device 304. (The agents 308 may also be other types of computing programs.) The agents 308 periodically poll the server 302. As will be described, each of the agents 308 identifies itself by a unique identifier (relative to the other agents) during polling. The server 302 in response initially provides a polling interval time indicating how long each agent is to wait before again polling the server. At some point, the server 302 is instructed to cause the agents 308 to each synchronously start a task. At that point, the server 302 determines a task start time, and transmits it to the agents 308 in response to their pollings of the server 302. This is described in more detail later in the detailed description.

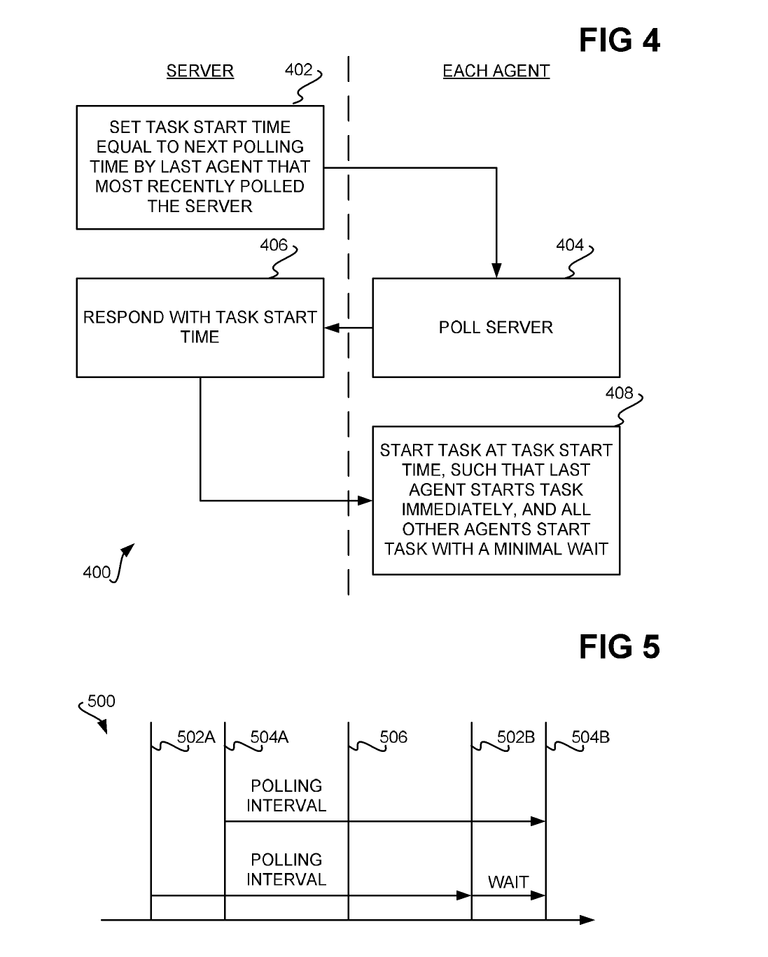

FIG. 4 shows a method 400 for efficiently synchronizing the task start time for performing a task by each of the agents 308 that periodically poll the server 302, according to an embodiment of the invention. The method 400 presumes that the agents 308 have been periodically polling the server 302 to learn when they should start the task. The method 400 is thus performed in response to an instruction to have the agents 308 start the task. For instance, a user like a network administrator may issue this instruction, at which time the method 400 is performed. The parts of the method 400 to the left of the dotted line are performed by the server 302, and the parts of the method 400 to the right of the dotted line are performed by each agent.

The server 302 sets the task start time equal to the next polling time by the last agent (402). The last agent is the agent that most recently polled the server. The next polling time is the time at which this last agent is expected to again poll the server 302. Thereafter, each agent polls the server 302 (404). In response, the server 302 responds with the task start time that has been determined (406). Each agent then starts the task at this task start time (408), such that all the agents start the task at the same time, in synchronization with one another.

The method 400 provides for efficient synchronous starting of the task by the agents 308. The task start time is such that as soon as the last agent polls the server and receives the task start time, this agent starts the task immediately, without delay. By comparison, all the other agents do have to wait for a length of time to start the task. However, this delay is minimized, such that the minimal wait incurred by the agents provides for efficient synchronization of the agents 308 starting the task.

FIG. 5 shows a timing diagram 500 that depicts exemplary performance of the method 400, according to an embodiment of the invention. For simplicity, it is presumed that there are just two agents 308: the agent 308A and the agent 308B. Each of these agents 308 periodically polls the server 302 at regular intervals. For example, the agent 308A polls the server 302 at time 502A, and again polls the server 302 at time 502B, where the difference between the times 502A and 502B is the polling interval time. Likewise, the agent 308B polls the server 302 at time 504A, and again polls the server 302 at time 504B, where the difference between the times 504A and 504B is again the polling interval time.

At time 506, the server 302 receives the instruction to cause the agents 308 to synchronously start the task in question. Therefore, the method 400 is performed. In part 402, the server 302 determines the task start time as equal to the next polling time by the last agent that most recently polled the server 302. In the example of FIG. 5, the last agent is the agent 308B, because the agent 308B most recently polled the server 302 at the time 504A, as compared to the agent 308A having least recently polled the server 302 at the time 502A. Therefore, the task start time is set equal to the next polling time at which it is expected that the agent 308B will poll the server 302, which is the time 504B.

The agent 308A next polls the server 302 in part 404 of the method 400, at the time 502B, and the server 302 responds with the task start time 504B. Therefore, the agent 308A waits until the time 504B before starting the task in part 408. The agent 308B likewise polls the server 302 in part 404 of the method 400, at the time 504B, and the server 302 again responds with the task start time 504B. Because this is the current time (i.e., the agent 308B has polled the server at the time 504B), the agent 308B starts the task in part 408 immediately.

The method 400 thus provides for the most efficient synchronization of the agents 308 starting the task, where the agents 308 poll the server 302 to learn when to start the task. The agent that has most recently polled the server 302 when the server 302 learns that it is to have the agents 308 start the task is the last agent, and starts the next at its next polling time, immediately and without delay. This is the agent 308B in the example of FIG. 5. All the other agents start the task with a minimal delay. Thus, the agent 308A in the example of FIG. 5 waits from the time 502B when it polls the server 302 to learn the task start time 504B, until the task start time 504B. This delay is minimal, in that if it were any less, the task start times over both the agents 308A and 308B could not be synchronized with one another.

One of ordinary skill within the art can appreciate that the agents 308 should have the same system time in order to start the task in a synchronous manner. Where the agents 308 are running on the same computing device 304, they inherently have the same system time. However, at least one of the agents 308 is running on a different computing device, ensuring the same system time over the different computing devices is easily ensured by initially synchronizing the system time with one another, or with an external clock, such as a network time server running the network time protocol (NTP), as is understood by those of ordinary skill within the art.

Furthermore, the method 400 that has been described does not take into consideration the delay from the time when an agent polling the server 302 and the time when the agent receives a response back from the server 302. If the server response time is long, variations can result in the task start times among the agents 308. In one embodiment, this issue is accommodated by the agents 308 measuring the server response time when polling the server 302, and communicating this response time to the server 302. As such, the server 302 can take into account its response time to each agent when communicating the task start time to the agent. For example, the maximum response time for a given agent may be added to the task start time when the server 302 communicates the task start time to this agent.

The server 302 may not know a priori the number of agents 308 that will be polling the server 302. As such, if there are a large number of agents 308 that are polling the server 302 too frequently, the server 302 can potentially become overloaded with polling requests, affecting performance. Therefore, in one embodiment, the server 302 counts the number of unique agents 308 that have polled the server 302 within a given time period in which it can be substantially guaranteed that all the agents 308 that will poll the server 302 have polled the server 302 at least once. The server 302 can then calculate a polling interval time based on this number of agents 308, where the polling interval time ensures that the server 302 will not be overloaded with the polling requests. The next time each of the agents 308 polls the server 302, the server 302 then returns the polling interval time, such that the agent in question waits until this polling interval time has elapsed before again polling the server. All of this desirably occurs before the method 400 is performed.

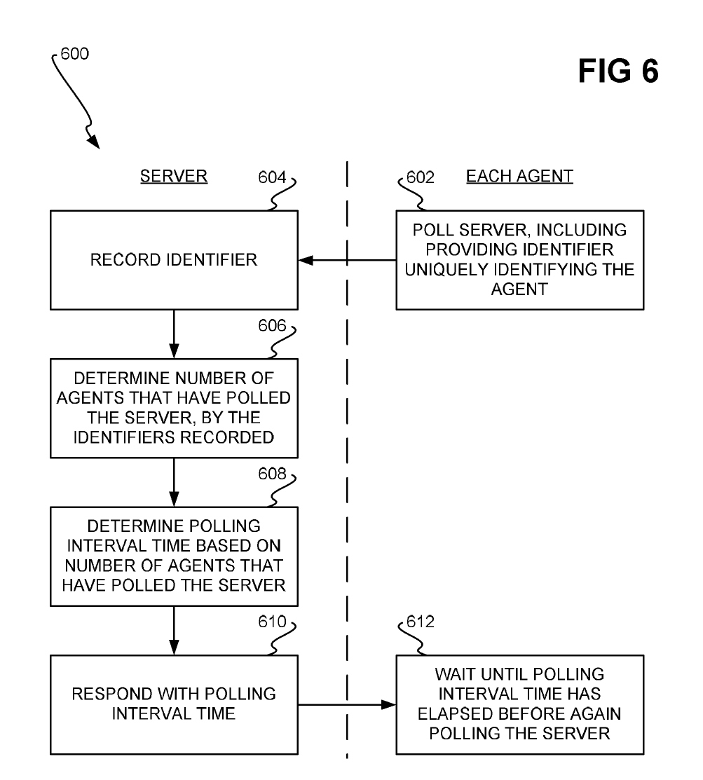

FIG. 6 shows a method 600 for determining such a polling interval time that ensures that the server 302 is not overloaded with polling requests from the agents 308, according to an embodiment of the invention. The method 600 is desirably performed before the method 400 is performed. The parts of the method 600 to the left of the dotted line are performed by the server 302, and the parts of the method 600 to the right of the dotted line are performed by each agent.

Each agent polls the server 302, and provides an identifier that uniquely identifies the agent in question in comparison and in relation to the other agents (602). The server 302 in response records these identifiers within a storage thereof (604), such as a semiconductor memory or a hard disk drive. The server 302 waits to proceed to part 606 from part 604 for a sufficiently long period of time that it can be at least substantially guaranteed that each of the agents 308 has polled the server 302 at least once. For instance, it may be presumed that no agent will wait more than sixty seconds between pollings, such that the server 302 may wait for more than sixty seconds before performing part 606, so that the unique identifiers of substantially all the agents 308 have been recorded.

Next, the server 302 determines the number of agents 308 that have polled the server 302 (606). This is achieved by simply counting the number of unique identifiers that have been recorded in part 604. Since the identifier of each agent is unique and does not change, the number of unique identifiers that are recorded by the server 302 corresponds to the number of the agents 308.

The server 302 then determines a polling interval time based on this unique number of agents 308 that have polled the server 302 (608). The polling interval time is determined so that where each of the agents 308 polls the server 302 at this interval, the server 302 will not be overloaded. In one embodiment, the polling interval time is determined by multiplying the number of agents 308 that have been counted by a base polling time. The resulting product is then set as the polling interval time.

Thereafter, upon the agents 308 polling the server 302, the server 302 responds with the polling interval time (610). As such, each of the agents 308 waits until the polling interval time has elapsed before again polling the server 302 (612). In this way, it can be ensured that the server 302 is not overloaded with polling requests from the agents 308, insofar as the server 302 is instructing the agents 308 how long to wait between successive pollings of the server 302.

It is noted that in one embodiment, the server 302 may or may not respond to a given polling request by an agent. Furthermore, when the server 302 does respond to a polling request, it may simply respond with a number corresponding to a time. The agent thus has to know whether the indicated time is the polling interval time or the task start time. In one embodiment, this is achieved by the server 302 sending the polling interval time as a negative number, and by the server 302 sending the task start time as a positive number. An agent receiving a negative number from the server 302 thus knows that the time indicated is the polling interval time, and takes the absolute value of this negative number to determine the polling interval time. Likewise, an agent receiving a positive number from the server 302 knows that the time indicated is the task start time.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A computerized method comprising:
setting a task start time by a server, the task start time set equal to a next polling time by a last agent that has most recently polled the server, the next polling time being a time at which the last agent is expected to again poll the server;
in response to each of a plurality of agents, including the last agent, polling the server, the server responding with the task start time; and,
at each of the plurality of agents, starting a task at the task start time, such that all of the plurality of agents start the task at a same time,
wherein all of the plurality of agents except for the last agent have to wait for the task start time to start the task after polling the server, and the last agent starts the task immediately after polling the server.

2. The method of claim 1, wherein the method is performed responsive to an instruction to have the plurality of agents start the task.

3. The method of claim 1, further comprising, initially:
each of the plurality of agents polling the server, including providing an identifier that uniquely identifies the agent compared to other agents;
the server recording the identifier of each agent polling the server so that the server is able to determine a number of the agents that have polled the server;
the server determining a polling interval time based on the number of the agents that have polled the server, the polling interval time indicating how long each agent waits between successive pollings of the server; and,
in response to each of the plurality of agents polling the server, the server responding with the polling interval time that has been determined, such that each agent waits to again poll the server until the polling interval time has elapsed.

4. The method of claim 3, wherein the task start time is set equal to the next polling time by the last agent that has most recently polled the server by adding the polling interval time to a most recent time that the last agent has polled the server.

5. The method of claim 3, wherein the polling interval time is sent from the server to each agent as a negative number to distinguish the polling interval time from the task start time, the task start time sent from the server to each agent as a positive number, each agent taking an absolute value of the negative number to determine the polling interval time.

6. The method of claim 3, further comprising the server determining the number of the agents that have polled the server by counting a number of unique identifiers that have been received from the plurality of agents polling the server and recorded by the server during a predetermined period of time in which it is at least substantially guaranteed that each agent has polled the server at least once.

7. The method of claim 3, wherein the server determining the polling interval time based on the number of the agents that have polled the server by multiplying the number of the agents that have polled the server by a base polling time.

8. The method of claim 1, wherein the server is a hypertext transport protocol (HTTP) server implemented at least in hardware.

9. The method of claim 8, wherein each agent is a web browsing computer program.

10. The method of claim 1, wherein each agent is a computer program running on a computing device implemented at least in hardware.

11. The method of claim 10, wherein one of:
the plurality of agents are running on a same computing device; and,
at least two of the agents are running on different computing devices.

12. The method of claim 1, wherein the server and the agents are communicatively connected to one another over a network.

13. A computerized system comprising:
one or more computing devices, a plurality of agents running on the computing devices;
a server implemented at least in hardware and communicatively connected with the plurality of agents, the server setting a task start time equal to a next polling time by a last agent of the plurality of agents, the last agent having most recently polled the server, the next polling time being a time at which the last agent is expected to again poll the server,
such that in response to each of the plurality of agents polling the server, the server responds with the task start time, and in response each of the plurality of agents starts a task at the task start time, so that all of the plurality of agents start the task at a same time,
wherein all of the plurality of agents except for the last agent have to wait for the task start time to start the task after polling the server, and the last agent starts the task immediately after polling the server.

14. The system of claim 13, wherein the server sets the task start time in response to an instruction to the server to have the plurality of agents start the task.

15. The system of claim 13, wherein each of the plurality of agents provides, when polling the server, an identifier that uniquely identifies the agent compared to other agents, the server record the identifier of each agent polling the server within a storage of the server so that the server is able to determine a number of the agents that have polled the server.

16. The system of claim 15, wherein the server is to determine a polling interval time based on the number of agents that have polled the server, the polling interval time indicating how long each agent waits between successive pollings of the server,
the server, response to each agent polling the server, transmitting the polling interval time that has been determined, such that each agent waits to again poll the server until the polling interval time has elapsed.

17. The system of claim 16, wherein the polling interval time is sent from the server to each agent as a negative number to distinguish the polling interval time from the task start time, the task start time sent from the server to each agent as a positive number, each agent taking an absolute value of the negative number to determine the polling interval time.

18. The system of claim 13, wherein the server is a hypertext transport protocol (HTTP) server implemented at least in hardware.

19. The system of claim 18, wherein each agent is a web browsing computer program.

20. A computer-readable medium having one or more computer programs stored thereon and executable by a server to perform a method comprising:
in response to each of a plurality of agents polling the server, including providing an identifier that uniquely identifies the agent compared to other agents,
the server recording the identifier of each agent polling the server so that the server is able to determine a number of the agents that have polled the server;
the server determining a polling interval time based on the number of the agents that have polled the server, the polling interval time indicating how long each agent waits between successive pollings of the server;
in response to each of the plurality of agents polling the server,
the server responding with the polling interval time that has been determined, such that each agent waits to again poll the server until the polling interval time has elapsed;
the server setting a task start time equal to a next polling time by a last agent of the plurality of agents that has most recently polled the server, the next polling time being a time at which the last agent is expected to again poll the server; and,
in response to each of the plurality of agents, including the last agent, polling the server, the server responding with the task start time,
such that each of the plurality of agents starts a task at the task start time so that all of the plurality of agents start the task at a same time,
wherein all of the plurality of agents except for the last agent have to wait for the task start time to start the task after polling the server, and the last agent starts the task immediately after polling the server.
